(19) United States
(12) Patent Application Publication
(10) Pub. No.: US 2022/0005208 A1
(43) Pub. Date: Jan. 6, 2022

(54) SPEED MEASUREMENT METHOD AND APPARATUS, ELECTRONIC DEVICE, AND STORAGE MEDIUM

(71) Applicant: SHANGHAI SENSETIME INTELLIGENT TECHNOLOGY CO., LTD., Shanghai (CN)

(72) Inventors: Kunlin YANG, Shanghai (CN); Jun HOU, Shanghai (CN); Shuai YI, Shanghai (CN)

(21) Appl. No.: 17/477,746

(22) Filed: Sep. 17, 2021

Related U.S. Application Data
(63) Continuation of application No. PCT/CN2020/121491, filed on Oct. 16, 2020.

(51) Int. Cl. G06T 7/246; G06T 7/73; G06K 9/32; G06K 9/46; G06K 9/00; G08B 21/02

(52) U.S. Cl. CPC G06T 7/246; G06T 7/73; G06K 9/3233; G06T 2207/10028; G06K 9/00778; G08B 21/02; G06K 9/4604

(57) ABSTRACT

A speed measurement method and apparatus, an electronic device and a storage medium are provided. The method includes: a first image to be processed and a second image to be processed are acquired, each of the first image to be processed and the second image to be processed including a first target; a first position of the first target in the first image to be processed, a second position of the first target in the second image to be processed, and a first transmission parameter of a first moving distance are acquired; and a speed of the first target is obtained according to the first moving distance, the first transmission parameter and moving time, the moving time being obtained according to a timestamp of the first image to be processed and a timestamp of the second image to be processed.

### CROSS-REFERENCE TO RELATED APPLICATIONS

This is a continuation application of International Patent Application No. PCT/CN2020/121491, filed on Oct. 16, 2020, which claims priority to Chinese Patent Application No. 202010613426.X, filed on Jun. 30, 2020. The disclosures of International Patent Application No. PCT/CN2020/121491 and Chinese Patent Application No. 202010613426.X are hereby incorporated by reference in their entireties.

### TECHNICAL FIELD

The disclosure relates to the technical field of computers, and particularly to a speed measurement method and apparatus, an electronic device, and a storage medium.

### BACKGROUND

With the development of a computer vision technology, application of the computer vision technology has become more and more widely. Many applications include measurement of a moving speed of a target (for example, a person and an object) based on the computer vision technology.

In a related art, a moving speed of a target is obtained based on a moving distance of the target in an image and moving time of the target. However, there is a large difference between the moving distance in the image and a physical moving distance of the target, and thus the obtained moving speed of the target is not so accurate.

### SUMMARY

The disclosure provides a speed measurement method and apparatus, an electronic device, and a storage medium.

A first aspect provides a speed measurement method, which may include the following operations.

A first image to be processed and a second image to be processed are acquired, each of the first image to be processed and the second image to be processed including a first target. A first position of the first target in the first image to be processed, a second position of the first target in the second image to be processed, and a first transmission parameter of a first moving distance are acquired. The first moving distance may be a distance between the first position and the second position, the first transmission parameter may represent a conversion relationship between the first moving distance and a first physical distance, the first physical distance may be a physical distance corresponding to the first moving distance, the first physical distance may be negatively correlated with a scale of the first position in the first image to be processed, and/or, the first physical distance may be negatively correlated with a scale of the second position in the second image to be processed. A speed of the first target is obtained according to the first moving distance, the first transmission parameter, and moving time. The moving time may be obtained according to a timestamp of the first image to be processed and a timestamp of the second image to be processed.

In the aspect, the first transmission parameter contains at least one of scale information of the first position or scale information of the second position, and a speed measurement apparatus obtains the speed of the first target according to the first transmission parameter, the first moving distance, and the moving time, so that the accuracy of the speed may be improved.

A second aspect provides a speed measurement apparatus, which may include a first acquisition unit, a second acquisition unit, and a first processing unit. The first acquisition unit may be configured to acquire a first image to be processed and a second image to be processed, each of the first image to be processed and the second image to be processed including a first target. The second acquisition unit may be configured to acquire a first position of the first target in the first image to be processed, a second position of the first target in the second image to be processed, and a first transmission parameter of a first moving distance. The first moving distance may be a distance between the first position and the second position, the first transmission parameter may represent a conversion relationship between the first moving distance and a first physical distance, the first physical distance may be a physical distance corresponding to the first moving distance, the first physical distance may be negatively correlated with a scale of the first position in the first image to be processed, and/or, the first physical distance may be negatively correlated with a scale of the second position in the second image to be processed. The first processing unit may be configured to obtain a speed of the first target according to the first moving distance, the first transmission parameter, and moving time. The moving time may be obtained according to a timestamp of the first image to be processed and a timestamp of the second image to be processed.

A third aspect provides a processor. The processor may be configured to execute the method in the first aspect and any possible implementation mode thereof.

A fourth aspect provides an electronic device, which may include a processor, a sending apparatus, an input apparatus, an output apparatus, and a memory. The memory may be configured to store a computer program code. The computer program code may include a computer instruction. When the processor executes the computer instruction, the electronic device may execute the method in the first aspect and any possible implementation mode thereof.

A fifth aspect provides a computer-readable storage medium, in which a computer program may be stored. The computer program may include a program instruction, and the program instruction may be executed by a processor to enable the processor to execute the method in the first aspect and any possible implementation mode thereof.

A sixth aspect provides a computer program product, which may include a computer program or instruction. The computer program or instruction may run in a computer to enable the computer to execute the method in the first aspect and any possible implementation mode thereof.

It is to be understood that the above general description and the following detailed description are only exemplary and explanatory and not intended to limit the disclosure.

### BRIEF DESCRIPTION OF THE DRAWINGS

In order to describe the technical solutions in the embodiments of the disclosure or the background art more clearly, the drawings required to be used for descriptions about the embodiments of the disclosure or the background art will be described below.

The accompanying drawings, which are incorporated in and constitute a part of this specification, illustrate embodiments consistent with the disclosure and, together with the specification, serve to describe the technical solutions of the disclosure.

FIG. 1 is a schematic diagram of a crowd image according to an embodiment of the disclosure.

FIG. 2 is a schematic diagram of a pixel coordinate system according to an embodiment of the disclosure.

FIG. 3 is a flowchart of a speed measurement method according to an embodiment of the disclosure.

FIG. 4 is a flowchart of another speed measurement method according to an embodiment of the disclosure.

FIG. 5 is a schematic diagram of a goal according to an embodiment of the disclosure.

FIG. 6 is a structure diagram of a speed measurement apparatus according to an embodiment of the disclosure.

FIG. 7 is a hardware structure diagram of a speed measurement apparatus according to an embodiment of the disclosure.

### DETAILED DESCRIPTION

In order to make the solutions of the disclosure to be understood by those skilled in the art better, the technical solutions in the embodiments of the disclosure will be clearly and completely described below in combination with the drawings in the embodiments of the disclosure. It is apparent that the described embodiments are not all embodiments but only part of embodiments of the disclosure. All other embodiments obtained by those of ordinary skill in the art on the basis of the embodiments in the disclosure without creative work shall fall within the scope of protection of the disclosure.

Terms “first”, “second” and the like in the specification, claims and drawings of the disclosure are adopted not to describe a specific sequence but to distinguish different objects. In addition, terms “include” and “have” and any variations thereof are intended to cover nonexclusive inclusions. For example, a process, method, system, product, or device including a series of steps or units is not limited to the steps or units which have been listed but optionally further includes steps or units which are not listed or optionally further includes other steps or units intrinsic to the process, the method, the product, or the device.

It is to be noted that in the disclosure, “at least one (item)” refers to one or more. “Multiple” refers to two or more than two. “At least two (items)” refers to two, or three, or more than three. “And/or” is used to describe an association relationship between associated objects, and may represent existence of three relationships. For example, “A and/or B” may represent three conditions, i.e., independent existence of A, independent existence of B, and existence of both A and B, A and B being singular or plural. Character “/” may represent that previous and next associated objects form an “or” relationship, and refers to any combination of these items, including a single item or any combination of multiple items. For example, at least one (item) of a, b, or c may represent a, b, c, “a and b”, “a and c”, “b and c”, or “a, b, and c”, a, b, and c being singular or plural. Character “/” may also represent a division sign in mathematical operations. For example, a/b refers to dividing a by b, 6/3=2. “At least one (item) of the following” or similar expression are understood in the same manner

“Embodiment” mentioned herein means that a specific feature, structure, or characteristic described in combination with an embodiment may be included in at least one embodiment of the disclosure. The phrase in various locations of the specification does not always refer to the same embodiment or an independent or alternative embodiment mutually exclusive of another embodiment. It is explicitly and implicitly understood by those skilled in the art that the embodiments described in the disclosure may be combined with other embodiments.

Some concepts to be mentioned below are defined at first. In the embodiments of the disclosure, an object point refers to a point in a real world, a physical distance refers to a distance in the real world, and a physical size refers to a size in the real world.

An object point corresponds to a pixel in an image. For example, a table is captured by a camera to obtain an image A. If the table includes an object point a, and a pixel b in the image A is obtained by imaging the object point a, the object point a corresponds to the pixel b.

A physical region corresponds to a pixel region in an image. For example, a basketball court is captured by a camera to obtain an image B. If a pixel region c in the image A is obtained by imaging the basketball court, the basketball court corresponds to pixel region c.

In the embodiments of the disclosure, a scale of a close object in an image is large, and a scale of a distant object in the image is small. In the embodiments of the disclosure, “distant” refers to that a real object corresponding to the object in the image is at a long distance far from an imaging device that captures the image, and “close” refers to that a real object corresponding to the object in the image is at a short distance far from the imaging device that captures the image.

In an image, a scale of a pixel is positively correlated with a size of an object point corresponding to the pixel. Specifically, if the scale of the pixel in the image is larger, the size of the object point corresponding to the pixel is larger. For example, image A includes pixel a and pixel b, an object point corresponding to pixel a is object point 1, and an object point corresponding to pixel b is object point 2. If a scale of pixel a in image A is larger than a scale of pixel b in image A, a size of object point 1 is larger than a size of object point 2.

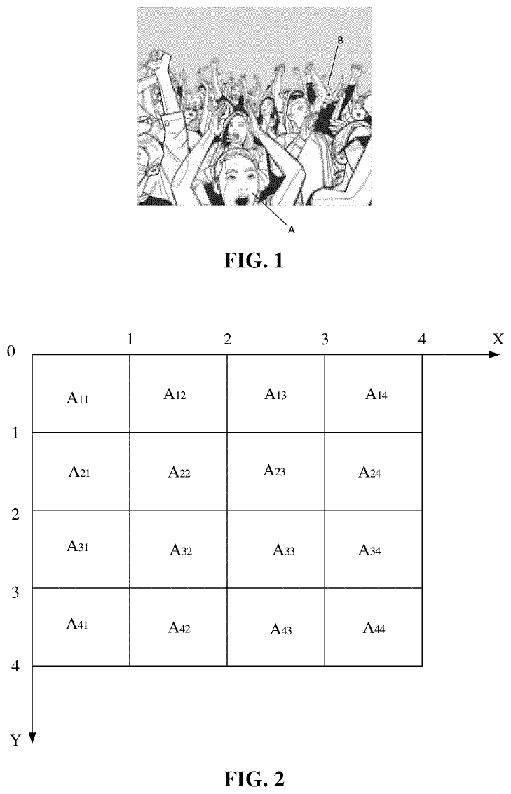

In an image, a scale of a position refers to a ratio of a size of an object at the position to a physical size of the object. For example, in FIG. 1, a scale of a position of person A is larger than a scale of a position of person B, and a size difference between the persons is relatively small (namely a difference between physical sizes of different persons is relatively small), so that an area of a pixel region covered by person A is larger than an area of a pixel region covered by person B.

In the embodiments of the disclosure, a position in an image refers to a position in a pixel coordinate of the image. In the embodiments of the disclosure, the abscissa of the pixel coordinate system is used to represent a column where the pixel is located, and the ordinate of the pixel coordinate system is used to represent a row where the pixel is located. For example, in an image illustrated in FIG. 2, a pixel coordinate system XOY is constructed by taking a top left corner of the image as a coordinate origin 0, taking a direction parallel to a row of the image as a direction of an X axis, and taking a direction parallel to a column of the image as a direction of a Y axis. Both the abscissa and the ordinate take pixel as the unit. For example, in FIG. 2, a coordinate of pixel A₁₁ is (1, 1), a coordinate of pixel A₂₃ is (3, 2), a coordinate of pixel A₄₂ is (2, 4), and a coordinate of pixel A₃₄ is (4, 3).

The embodiments of the disclosure are performed by a speed measurement apparatus. In some possible implementation modes, the speed measurement apparatus may be one of a mobile phone, a computer, a server, and a tablet computer. The embodiments of the disclosure will be described below in combination with the drawings in the embodiments of the disclosure.

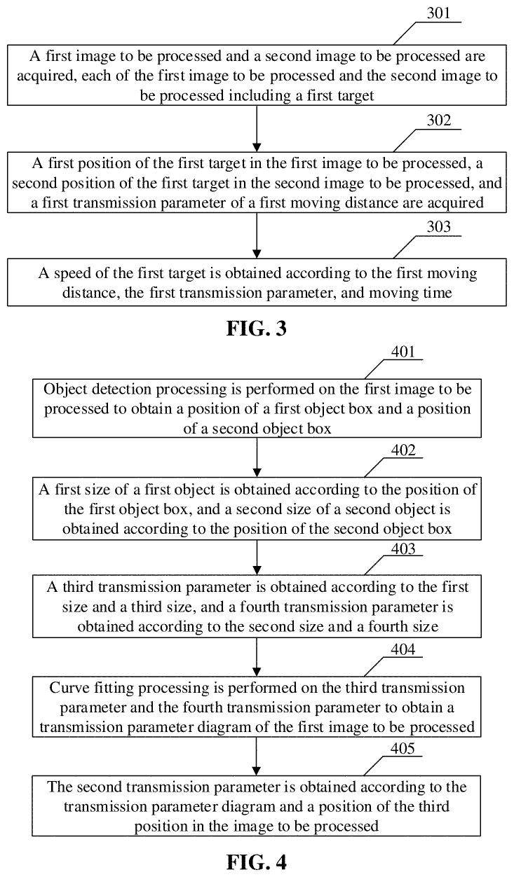

The embodiments of the disclosure will be described below in combination with the drawings in the embodiments of the disclosure. Referring to FIG. 3. FIG. 3 is a flowchart of a speed measurement method according to an embodiment of the disclosure.

In 301, a first image to be processed and a second image to be processed are acquired, each of the first image to be processed and the second image to be processed including a first target.

In the embodiment of the disclosure, each of the first image to be processed and the second image to be processed may include any content. For example, the first image to be processed may include a person, or the first image to be processed may include a road, a vehicle, and a head. The second image to be processed may include a person, or the second image to be processed may include an animal. The content in the first image to be processed and the content in the second image to be processed are not limited in the disclosure.

In the embodiment of the disclosure, the first target may be one of a person and an object. For example, the first target may be a person. Alternatively, the first target may be a vehicle. Alternatively, the first target may be an animal.

Each of the first image to be processed and the second image to be processed includes the first target. For example, the first image to be processed includes Zhang San, and the second image to be processed also includes Zhang San. For another example, the first image to be processed and the second image to be processed both include vehicle a.

In an implementation mode of acquiring the first image to be processed, the speed measurement apparatus receives the first image to be processed input by a user through an input component. The input component includes a keyboard, a mouse, a touch screen, a touch pad, an audio input unit, etc.

In another implementation mode of acquiring the first image to be processed, the speed measurement apparatus receives the first image to be processed sent by a first terminal. In some possible implementation modes, the first terminal may be any one of a mobile phone, a computer, a tablet computer, a server, or a wearable device.

In another implementation mode of acquiring the first image to be processed, the speed measurement apparatus is loaded with a camera component, and the camera component includes a camera. The speed measurement apparatus performs image capture using the camera component to obtain the first image to be processed.

In another implementation mode of acquiring the first image to be processed, the speed measurement apparatus selects a frame of image from an acquired video stream as the first image to be processed.

In an implementation mode of acquiring the second image to be processed, the speed measurement apparatus receives the second image to be processed input by the user through the input component. The input component includes a keyboard, a mouse, a touch screen, a touch pad, an audio input unit, etc.

In another implementation mode of acquiring the second image to be processed, the speed measurement apparatus receives the second image to be processed sent by a second terminal. In some possible implementation modes, the second terminal may be any one of a mobile phone, a computer, a tablet computer, a server, or a wearable device.

In another implementation mode of acquiring the second image to be processed, the speed measurement apparatus is loaded with the camera component, and the camera component includes the camera. The speed measurement apparatus performs image capture using the camera component to obtain the second image to be processed.

In another implementation mode of acquiring the second image to be processed, the speed measurement apparatus selects a frame of image from the acquired video stream as the second image to be processed.

As an implementation mode in some possible implementation modes, the speed measurement apparatus is in communication connection with a monitoring camera. The speed measurement apparatus acquires a monitoring video stream acquired by the monitoring camera through the communication connection, and selects two frames of images from the monitoring video stream as the first image to be processed and the second image to be processed respectively.

In 302, a first position of the first target in the first image to be processed, a second position of the first target in the second image to be processed, and a first transmission parameter of a first moving distance are acquired.

In the embodiment of the disclosure, the position of the first target in the first image to be processed may be a position of a target box including the first target in the first image to be processed. The position of the first target in the first image to be processed may be a position of a pixel in a pixel region covered by the first target in the first image to be processed. The position of the first target in the second image to be processed may be a position of a target box including the first target in the second image to be processed. The position of the first target in the second image to be processed may be a position of a pixel in a pixel region covered by the first target in the second image to be processed.

In the embodiment of the disclosure, the first moving distance is a distance between the first position and the second position, namely the first moving distance is a distance in a pixel coordinate system. For example, the first position is (3, 5), namely the position of the first target in the first image to be processed is (3, 5). The second position is (7, 8), namely the position of the first target in the second image to be processed is (7, 8). In such case, the first moving distance is \sqrt{(7−3)²+(8−5)²}=5 .

In the embodiment of the disclosure, a physical distance (including the abovementioned first physical distance) refers to a distance in a real world. A physical distance corresponding to the first moving distance is a first physical distance. The first transmission parameter represents a conversion relationship between the first moving distance and the first physical distance. For example, assume that a timestamp of the first image to be processed is t1, a timestamp of the second image to be processed is t2, and the first target is Zhang San. If the first moving distance obtained by the speed measurement apparatus according to the first position and the second position is d1, the speed measurement apparatus may convert d1 into a moving distance (i.e., the first physical distance) of Zhang San from t1 to t2 in the real world using the first transmission parameter. In some possible implementation mode, the first transmission parameter is a ratio of the first moving distance to the first physical distance.

In the embodiment of the disclosure, the first physical distance is negatively correlated with a scale of the first position in the first image to be processed, and/or, the first physical distance is negatively correlated with a scale of the second position in the second image to be processed. Such correlation may include at least one of the following conditions.

(1) The first physical distance obtained by the speed measurement apparatus according to the first moving distance and the first transmission parameter is negatively correlated with the scale of the first position in the first image to be processed.

(2) The first physical distance obtained by the speed measurement apparatus according to the first moving distance and the first transmission parameter is negatively correlated with the scale of the second position in the second image to be processed.

(3) The first physical distance obtained by the speed measurement apparatus according to the first moving distance and the first transmission parameter is negatively correlated with the scale of the first position in the first image to be processed, and the first physical distance is negatively correlated with the scale of the second position in the second image to be processed.

In 303, a speed of the first target is obtained according to the first moving distance, the first transmission parameter and moving time.

In the embodiment of the disclosure, the moving time is time consumed in movement of the first target for the first moving distance. The speed measurement apparatus may obtain the moving time according to the timestamp of the first image to be processed and the timestamp of the second image to be processed.

In a possible implementation mode, the smaller timestamp in the timestamp of the first image to be processed and the timestamp of the second image to be processed is called a small timestamp, and the larger timestamp in the timestamp of the first image to be processed and the timestamp of the second image to be processed is called a large timestamp. Starting time of the moving time is the small timestamp, and ending time of the moving time is the large timestamp. For example, the timestamp of the first image to be processed is 16:54:30 on Jun. 27, 2020, and the timestamp of the second image to be processed is 16:54:33 on Jun. 27, 2020. In such case, the small timestamp is 16:54:30 on Jun. 27, 2020, and the large timestamp is 16:54:33 on Jun. 27, 2020.

In the embodiment of the disclosure, the speed of the first target is a speed of the first target in the real world. In an implementation mode of obtaining the speed of the first target, the speed measurement apparatus obtains a moving distance (called a second moving distance hereinafter) of the first target in the real world according to the first transmission parameter and the first moving distance. The speed measurement apparatus may obtain the speed of the first target according to the first physical moving distance and the moving time. For example, assume that the first transmission parameter represents the ratio of the first moving distance to the first physical distance, the first transmission parameter is 0.1 centimeters, the first moving distance is 10, and the moving time is 0.5 seconds. The speed measurement apparatus may obtain the second moving distance according to the following formula: 10/0.1 centimeters=100 centimeters=1 meter. The speed measurement apparatus may obtain the speed of the first target in the real world according to the following formula: 1/0.5 meters/second=2 meters/second.

In another possible implementation mode, the speed measurement apparatus obtains a speed (called a virtual speed hereinafter) of the first target in the image according to the first moving distance and the moving time. The speed measurement apparatus obtains the speed of the first target in the real world according to the virtual speed and the first transmission parameter.

The first transmission parameter contains scale information of the first position and/or scale information of the second position, and the speed measurement apparatus obtains the speed of the first target according to the first transmission parameter, the first moving distance, and the moving time. In this way, the accuracy of the speed may be improved.

As an implementation mode in some possible implementation modes, the speed measurement apparatus executes the following operations to acquire the first transmission parameter.

In 1, a second transmission parameter of a third position is acquired.

In the embodiment of the disclosure, the third position is a position on a connecting line between the first position and the second position. It is to be understood that, although the first position is a position in the first image to be processed and the second position is a position in the second image to be processed, in the embodiment of the disclosure, the speed measurement apparatus may determine the third position in the pixel coordinate system according to the first position and the second position because the pixel coordinate system of the first image to be processed is the same as the pixel coordinate system of the second image to be processed. The third position may be a position in the first image to be processed, or the third position may be a position in the second image to be processed. For example, the first position is (3, 4), and the second position is (7, 8). Assume that the third position is a middle position (5, 6) between the first position and the second position. In such case, the third position may represent a pixel in a fifth row and a sixth column of the first image to be processed, or the third position may represent a pixel in a fifth row and a sixth column of the second image to be processed.

In the embodiment of the disclosure, the speed measurement apparatus may determine a pixel in the first image to be processed according to the third position, or the speed measurement apparatus may determine a pixel in the second image to be processed according to the third position. The pixel determined by the speed measurement apparatus according to the third position is called a first pixel. The second transmission parameter represents a conversion relationship between a size of the first pixel and a size of a first object point, and the first object point is an object point corresponding to the first pixel. For example, the second transmission parameter represents a conversion relationship between a length of the first pixel and a length of the first object point. For another example, the second transmission parameter represents a conversion relationship between a height of the first pixel and a height of the first object point. For another example, the second transmission parameter represents a conversion relationship between a width of the first pixel and a width of the first object point.

A ratio of the size of the first pixel to the size of the first object point is called a first ratio. In the embodiment of the disclosure, the first ratio is negatively correlated with a scale of the first pixel in the image. For example, the first pixel belongs to the first image to be processed, and assume that the first ratio is a ratio of the length of the first pixel to the length of the first object point. In such case, if a scale of the first pixel in the first image to be processed is larger, the first ratio is smaller. Considering that any two pixels in the first image to be processed are the same length, namely the length of the first pixel is invariable, if the scale of the first pixel is larger, the length of the first object point is smaller, namely the size of the first object point is negatively correlated with the scale of the first pixel.

For another example, assume that the first ratio is a ratio of the length of the first pixel to the length of the first object point, and the first pixel belongs to the second image to be processed. In such case, if a scale of the first pixel in the second image to be processed is larger, the first ratio is smaller. Considering that any two pixels in the second image to be processed are the same length, namely the length of the first pixel is invariable, if the scale of the first pixel is larger, the length of the first object point is smaller, namely the size of the first object point is negatively correlated with the scale of the first pixel.

From the above, since the size of the first object point is obtained according to the size of the first pixel and the second transmission parameter, and the size of the first pixel is a fixed value, the second transmission parameter contains scale information of the first pixel. In an implementation mode of acquiring the second transmission parameter of the third position, the speed measurement apparatus receives the second transmission parameter input by the user through the input component. The input component includes a keyboard, a mouse, a touch screen, a touch pad, an audio input unit, etc.

In another implementation mode of acquiring the second transmission parameter of the third position, the speed measurement apparatus receives the second transmission parameter sent by a third terminal. In some possible implementation modes, the third terminal may be any one of a mobile phone, a computer, a tablet computer, a server, and a wearable device. The third terminal may be the same as or different from the first terminal.

In 2, the first transmission parameter is obtained according to the second transmission parameter.

In a possible implementation mode, a scale of a pixel is linearly correlated with an abscissa of the pixel, and/or, the scale of the pixel is linearly correlated with an ordinate of the pixel. A scale of the third position is linearly correlated with the scale of the first position, and/or, the scale of the third position is linearly correlated with the scale of the second position. Therefore, the speed measurement apparatus may determine the transmission parameter of the first moving distance according to a transmission parameter of a middle position between the first position and the second position, namely the first transmission parameter is determined according to the second transmission parameter. As an implementation mode in some possible implementation modes, the third position is a middle position between the first position and the second position.

In the embodiment of the disclosure, the first transmission parameter is positively correlated with the second transmission parameter. Assume that the first transmission parameter is b₁, and the second transmission parameter is b₂. In a possible implementation mode, b₁, b₂ satisfy formula (1).

b₂=k×b₁ (1).

Herein, k is a positive number. In some possible implementation modes, k=1.

In another possible implementation mode, b₁, b₂ satisfy formula (2).

b₂=k×b₁+c (2).

Herein, k is a positive number, and c is a real number. In some possible implementation modes, k=1, and c=0.

In another possible implementation mode, b₁, b₂ satisfy formula (3).

b₂=\sqrt{k×b₁+c} (3).

Herein, k is a positive number, and c is a real number. In some possible implementation modes, k=1, and c=0.

References are made to FIG. 4. FIG. 4 is a flowchart of a possible implementation of 1 according to an embodiment of the disclosure.

In 401, object detection processing is performed on the first image to be processed to obtain a position of a first object box and a position of a second object box.

In the embodiment of the disclosure, a detection target of object detection processing is an object of which a size is close to a determined value. For example, an average length of faces is 20 centimeters, and the detection target of object detection processing may be a face. For another example, an average height of persons is 1.65 meters, and the detection target of object detection processing may be a human body. For another example, heights of all goals as illustrated in FIG. 5 in a football field are determined (for example, 2.44 meters), and the detection target of object detection processing may be a goal.

In the embodiment of the disclosure, the object box may be in any shape. The shape of the object box (including the first object box and the second object box) is not limited in the disclosure. In some possible implementation modes, the shape of the object box may include at least one of a rectangle, a rhombus, a round, an ellipse, or a polygon.

In the embodiment of the disclosure, the position of the object box (including the position of the first object box and the position of the second object box) is used to determine a pixel region in the object box, i.e., a position of the object box in the image to be processed. For example, under the condition that the shape of the object box is a rectangle, the position of the object box may include coordinates of any pair of opposite angles in the rectangle. A pair of opposite angles refers to two vertexes on a diagonal of the rectangle. For another example, under the condition that the shape of the object box is a rectangle, the position of the object box may include a position of a geometric center of the rectangle, a length of the rectangle, and a width of the rectangle. For another example, under the condition that the shape of the object box is a round, the position of the object box may include a position of a circle center of the object box and a radius of the object box.

In the embodiment of the disclosure, the number of the detection targets of object detection processing is not less than 1. For example, under the condition that the detection target is a face, object detection processing may be performed on the image to be processed to obtain a position of a face box including the face. For another example, under the condition that the detection target includes a face and a human body, object detection processing may be performed on the image to be processed to obtain a position of a face box including the face and a position of a human body box including the human body. For another example, under the condition that the detection target includes a face, a human body, and a screw, object detection processing may be performed on the image to be processed to obtain a position of a face box including the face, a position of a human body box including the human body, and a position of a screw box including the screw. In some possible implementation modes, the detection target of object detection processing includes at least one of a face, a foot, a human body, a screw, or a goal.

In a possible implementation mode, object detection processing on the image to be processed may be implemented through a convolutional neural network. The convolutional neural network is trained by taking an image with labeling information as training data such that the trained convolutional neural network may complete object detection processing on an image. The labeling information of the image in the training data is position information of an object box, and the object box includes a detection target of object detection processing.

In another possible implementation mode, object detection processing may be implemented through an object detection algorithm. The object detection algorithm may be one of You Only Look Once (YOLO), Deformable Part Model (DMP), Single Shot multiBox Detector (SSD), Faster-Region-based Convolutional Neural Network (RCNN) algorithm, etc. The object detection algorithm for implementing the object detection processing is not limited in the disclosure.

The speed measurement apparatus performs object detection processing on the first image to be processed to obtain the position of the first object box including a first object and the position of the second object box including a second object. A detection target in the first object box is different from a detection target in the second object box. For example, the detection target in the first object box is the face of Zhang San, and the detection target in the second object box is the face of Li Si. For another example, the detection target in the first object box is the face of Zhang San, and the detection target in the second object box is a sign.

In 402, a first size of a first object is obtained according to the position of the first object box, and a second size of a second object is obtained according to the position of the second object box.

The speed measurement apparatus may determine a size of the detection target in the object box according to the position of the object box. For example, under the condition that the shape of the object box is a rectangle, the speed measurement apparatus may determine a length and width of the object box according to the position of the object box to further determine a length and width of the detection target in the object box.

The speed measurement apparatus may obtain the first size of the first object according to the position of the first object box and obtain the second size of the second object according to the position of the second object box.

In 403, a third transmission parameter is obtained according to the first size and a third size, and a fourth transmission parameter is obtained according to the second size and a fourth size.

In the embodiment of the disclosure, the third size is a physical size of the first object, and the fourth size of a physical size of the second object. For example, if the detection target in the first object box is a human body, the third size may be a height (for example, 170 centimeters) of the human body. For another example, if the detection target in the second object box is a face, the fourth size may be a length (for example, 20 centimeters) of the face.

The speed measurement apparatus may determine a pixel (i.e., a second pixel) in the first image to be processed according to the position of the first object box. For example, under the condition that the shape of the first object box is a rectangle, the speed measurement apparatus determines a position of a geometric center of the first object box according to the position of the first object box, and determines a pixel corresponding to the geometric center as the second pixel. For another example, under the condition that the shape of the first object box is a rectangle, the speed measurement apparatus determines a position of any vertex of the first object box according to the position of the first object box, and determines a pixel corresponding to the vertex as the second pixel. For another example, under the condition that the shape of the first object box is a round, the speed measurement apparatus determines a position of a circle center of the first object box according to the position of the first object box, and determines a pixel corresponding to the circle center as the second pixel. Similarly, the speed measurement apparatus may determine a pixel, i.e., a third pixel, in the second image to be processed according to the position of the second object box.

In the embodiment of the disclosure, a size of the second pixel is called a fifth size, a size of an object point corresponding to the second pixel is called a sixth size, a size of the third pixel is called a seventh size, and a size of an object point corresponding to the third pixel is called an eighth size. A conversion relationship between the fifth size and the sixth size is called the third transmission parameter, and a conversion relationship between the seventh size and the eighth size is called the fourth transmission parameter.

The speed measurement apparatus may obtain the third transmission parameter according to the first size and the third size, and may obtain the fourth transmission parameter according to the second size and the fourth size. Assume that the first size is s₁, the second size is s₂, the third size is s₃, the fourth size is s₄, the third transmission parameter is b₃, and the fourth transmission parameter is b₄.

In a possible implementation mode, s₁, s₃, b₃ satisfy formula (4).

$${b}_{3} = r \times {s}_{1} \text{/} {s}_{3} . \qquad ( 4 )$$

s₂, s₄, b₄ satisfy formula (5).

$${b}_{4} = r \times {s}_{2} \text{/} {s}_{4} . \qquad ( 5 )$$

Herein, r is a positive number. In some possible implementation modes, r=1.

In another possible implementation mode, s₁, s₃, b₃ satisfy formula (6).

$${b}_{3} = r \times {s}_{1} \text{/} {s}_{3} + c . \qquad ( 6 )$$

s₂, s₄, b₄ satisfy formula (7).

$${b}_{4} = r \times {s}_{2} \text{/} {s}_{4} + c . \qquad ( 7 )$$

Herein, r is a positive number, and c is a real number. In some possible implementation modes, r=1, c=0.

In another possible implementation mode, s₁, s₃, b₃ satisfy formula (8).

$${b}_{3} = \sqrt{r \times {s}_{1} \text{/} {s}_{3} + c} . \qquad ( 8 )$$

s₂, s₄, b₄ satisfy formula (9).

$${b}_{4} = \sqrt{r \times {s}_{2} \text{/} {s}_{4} + c} . \qquad ( 9 )$$

Herein, r is a positive number, and c is a real number. In some possible implementation modes, r=1, c=0.

In 404, curve fitting processing is performed on the third transmission parameter and the fourth transmission parameter to obtain a transmission parameter diagram of the first image to be processed.

In the first image to be processed, a scale of a pixel is linearly correlated with an abscissa of the pixel, and/or, the scale of the pixel is linearly correlated with an ordinate of the pixel. Therefore, the speed measurement apparatus may perform curve fitting processing on the third transmission parameter and the fourth transmission parameter to obtain the transmission parameter diagram of the first image to be processed. A transmission parameter of any pixel in the first image to be processed may be determined according to pixel values in the transmission parameter diagram.

A fifth pixel in the transmission parameter diagram is taken as an example Assume that a pixel value of the fifth pixel is a first pixel value, and a position of the fifth pixel in the transmission parameter diagram is the same as a position of a fourth pixel in the first image to be processed, namely the fifth pixel is a pixel corresponding to the fourth pixel in the first transmission parameter diagram. In such case, the speed measurement apparatus may determine a conversion relationship between a size (i.e., a ninth size) of the fourth pixel and a tenth size according to the first pixel value. The tenth size is a size of an object point corresponding to the fourth pixel.

Assume that the first pixel value is p₁, the ninth size is s₅, and the tenth size is s₆. In a possible implementation mode, p₁, s₅, s₆ satisfy formula (10).

$${p}_{1} = μ \times {s}_{5} \text{/} {s}_{6} . \qquad ( 10 )$$

Herein, μ is a positive number. In some possible implementation modes, μ=1.

In another possible implementation mode, p₁, s₅, s₆ satisfy formula (11).

$${p}_{1} = μ \times {s}_{5} \text{/} {s}_{6} + y . \qquad ( 11 )$$

Herein, μ is a positive number, and y is a real number. In some possible implementation modes, μ=1, and y=0.

In another possible implementation mode, p₁, s₅, s₆ satisfy formula (12).

$${p}_{1} = \sqrt{μ \times {s}_{5} \text{/} {s}_{6} + y} . \qquad ( 12 )$$

Herein, μ is a positive number, and y is a real number. In some possible implementation modes, μ=1, and y=0.

Similarly, the speed measurement apparatus may determine a transmission parameter of any pixel, except the fourth pixel, in the first image to be processed according to the transmission parameter diagram.

In 405, the second transmission parameter is obtained according to the transmission parameter diagram and a position of the third position in the image to be processed.

When the third position represents a position in the first image to be processed, the speed measurement apparatus may determine a reference pixel value from the transmission parameter diagram according to the third position. A position of a pixel corresponding to the reference pixel value in the transmission parameter diagram is the same as the third position. The speed measurement apparatus may further obtain the second transmission parameter according to the reference pixel value.

In the embodiment of the disclosure, the speed measurement apparatus obtains the third transmission parameter according to the first size and the third size, obtains the fourth transmission parameter according to the second size and the fourth size, and performs curve fitting processing on the third transmission parameter and the fourth transmission parameter to obtain the transmission parameter diagram. Then, the speed measurement apparatus may further determine the transmission parameter of any pixel in the first image to be processed according to the transmission parameter diagram.

It is to be understood that, when the third position represents a position in the second image to be processed, the speed measurement apparatus may perform object detection processing on the second image to be processed to obtain a transmission parameter diagram of the second image to be processed, to further determine the second transmission parameter.

As an implementation mode in some possible implementation modes, the speed measurement apparatus further executes the following operations before executing the operation in 404.

In 3, a confidence mapping is acquired.

In the embodiment of the disclosure, accuracy of a transmission parameter of a pixel is positively correlated with accuracy of a size of an object point corresponding to the pixel. Correspondingly, accuracy of the transmission parameter diagram is positively correlated with accuracy of the size of the first object and the size of the second object.

The accuracy of a size of an object with a fixed size is higher than the accuracy of a size of an object of which the size is in a floating range.

For example, a standard football goal has a width of 7.32 meters and a height of 2.44 meters. Heights of 90% of persons are 1.4 meters to 2 meters. The accuracy of the size of the football goal is higher than the accuracy of the height of the person.

For another example, a height of a standard basketball stand is 3.05 meters. Lengths of 95% of faces are 17 centimeters to 30 centimeters. The accuracy of the height of the basketball stand is higher than the accuracy of the length of the face.

For another example, a screw has a fixed length. Foot lengths of 95% of persons are 20 centimeters to 35 centimeters. The accuracy of the length of the screw with the fixed length is higher than the accuracy of the length of the foot.

In some possible implementation modes, the object with the fixed size may be an object with a fixed size in a specific scene, for example, a boarding sign in a departure lounge, for another example, a chair in a gymnasium, and for another example, a desk in an office.

In the embodiment of the disclosure, the confidence mapping represents a mapping between an object type and a confidence of a transmission parameter. For example, the confidence mapping may refer to Table 1.

TABLE 1

| Object type | Confidence |
|---|---|
| Goal, basketball stand, and boarding sign | 0.9 |
| Human body | 0.8 |
| Face | 0.7 |
| Foot | 0.65 |

In an implementation mode of acquiring the confidence mapping, the speed measurement apparatus receives the confidence mapping input by the user through the input component. The input component includes a keyboard, a mouse, a touch screen, a touch pad, an audio input unit, etc.

In another implementation mode of acquiring the confidence mapping, the speed measurement apparatus receives the confidence mapping sent by a fourth terminal. In some possible implementation modes, the fourth terminal may be any one of a mobile phone, a computer, a tablet computer, a server, and a wearable device. The fourth terminal may be the same as or different from the first terminal.

In 4, a first confidence of the third transmission parameter is obtained according to an object type of the first object and the confidence mapping.

After acquiring the confidence mapping, the speed measurement apparatus may obtain the first confidence of the third transmission parameter according to the confidence mapping and the object type of the first object. For example, assume that the confidence mapping is illustrated in Table 1, and the object type of the first object is a human body. In such case, the first confidence is 0.9.

In some possible implementation modes, the speed measurement apparatus may perform feature extraction processing on a pixel region in the first object box to determine the object type of the first object.

As an implementation mode in some possible implementation modes, the speed measurement apparatus may determine a transmission parameter corresponding to an object in each object box according to an object type of the object in each object box. For example, the speed measurement apparatus may obtain a confidence (called a third confidence in the embodiment of the application) of the fourth transmission parameter according to an object type of the second object and the confidence mapping.

After obtaining the first confidence, the speed measurement apparatus executes the following operations during execution of the operation in 404.

In 5, a fifth transmission parameter is obtained according to the first confidence and the third transmission parameter.

In the embodiment of the disclosure, the fifth transmission parameter is positively correlated with the first confidence. Assume that the first confidence is c₁, and the fifth transmission parameter is b₅. In a possible implementation mode, c₁, b₅ satisfy formula (13).

b₅=a×c₁ (13).

Herein, a is a positive number. In some possible implementation modes, a=1.

In another possible implementation mode, c₁, b₅ satisfy formula (14).

b₅=a×c₁+e (14).

Herein, a is a positive number, and e is a real number. In some possible implementation modes, a=1, e=0.

In another possible implementation mode, c₁, b₅ satisfy formula (15).

b₅=\sqrt{a×c₁+e} (15).

Herein, a is a positive number, and e is a real number. In some possible implementation modes, a=1, e=0.

In 6, curve fitting processing is performed on the fourth transmission parameter and the fifth transmission parameter to obtain the transmission parameter diagram.

The speed measurement apparatus may perform curve fitting processing on the fourth transmission parameter and the fifth transmission parameter to improve the accuracy of the transmission parameter diagram.

As an implementation mode in some possible implementation modes, when the speed measurement apparatus executes the operation in 4 to obtain the third confidence and obtain a sixth transmission parameter according to the third confidence and the fourth transmission parameter, the speed measurement apparatus may perform curve fitting processing on the fifth transmission parameter and the sixth transmission parameter to obtain the transmission parameter diagram.

It is to be understood that, under the condition that the third position represents a position in the second image to be processed, the speed measurement apparatus may obtain the transmission parameter diagram of the second image to be processed based on the confidence mapping to improve the accuracy of the transmission parameter diagram of the second image to be processed.

As an implementation mode in some possible implementation modes, the speed measurement apparatus further executes the following operations before executing the operation in 4.

In 7, feature extraction processing is performed on a pixel region in the first object box to obtain feature data.

In the embodiment of the disclosure, the feature extraction processing may be convolution processing, or may be pooling processing, or may be a combination of convolution processing and pooling processing. In some possible implementation modes, the feature extraction processing may be implemented through a trained convolutional neural network, or may be implemented through a feature extraction model. No limits are made thereto in the disclosure.

The speed measurement apparatus may perform the feature extraction processing on a pixel region in an object box to extract semantic information in the pixel region in the object box to obtain feature data of the object box.

In an implementation mode for performing feature extraction processing on the pixel region in the first object box, convolution processing is performed on the pixel region in the first object box layer by layer through at least two convolutional layers to complete the feature extraction processing on the pixel region in the first object box. The convolutional layers in the at least two convolutional layers are sequentially connected in series, namely an output of a previous convolutional layer is an input of a next convolutional layer. Semantic information extracted through each convolutional layer is different. Specifically, the feature extraction processing abstracts features of the pixel region in the first object box step by step, and simultaneously discards relatively minor feature data. Relatively minor feature information refers to feature information except feature information available for determining an object type of an object in the first object box. Therefore, feature data extracted later is smaller in size but more concentrated in semantic information. Convolution processing may be performed on the pixel region in the first object box step by step through multiple convolutional layers to obtain the semantic information of the pixel region in the first object box.

In some possible implementation modes, the speed measurement apparatus may perform feature extraction processing on the pixel region in each object box to obtain feature data of the pixel region in each object box.

In 8, a score of the first object is obtained according to the feature data.

Considering that a practical size of an object with an invariable size may change, in the embodiment of the disclosure, a state of the object is determined according to feature data of the object to further obtain a score configured to represent a confidence of the size of the object. The score of the object is positively correlated with the confidence of the size of the object.

For example, assume that the object is a human body, and the size of the object is a height of the person. When the person stands upright, the height of the person is equal to a practical height of the person, and in such case, a confidence of the height of the person is highest. When the person walks, there is a relatively small error between a height of the person and the practical height of the person, and in such case, a confidence of the height of the person is the second highest. When the person lowers the head (for example, looking down at the phone), there is a small error between a height of the person and the practical height of the person, and in such case, a confidence of the height of the person is lower than that of the height of the person when walking. When the person sits, there is a relatively great error between a height of the person and the practical height of the person, and in such case, a confidence of the height of the person is low.

In the embodiment of the disclosure, the speed measurement apparatus may determine the score of the object in the object box according to the feature data extracted from the pixel region in the object box.

As an implementation mode in some possible implementation modes, the speed measurement apparatus may process the feature data of the object box using a classifier (for example, a support vector machine and a softmax function) to obtain the score of the object in the object box.

In some possible implementation modes, the speed measurement apparatus may process the pixel region in the object box using a neural network to obtain the score of the object in the object box. For example, the speed measurement apparatus trains the neural network through using a labeled image set as training data to obtain a trained neural network. An unlabeled image set is processed using the trained neural network to obtain a label of the unlabeled image set. The trained neural network is trained using the labeled image set, the unlabeled image set, and the label of the unlabeled image set to obtain an image processing neural network. Information in the label includes a position of an object box in an image and a score of an object in the object box.

The speed measurement apparatus may obtain the score of the first object according to the feature data of the first object. In some possible implementation modes, the speed measurement apparatus may obtain a score of each object in the first image to be processed.

When the score of the first object is obtained, the speed measurement apparatus executes the following operations during execution of the operation in 4.

In 9, a second confidence of the third transmission parameter is obtained according to the object type of the first object and the confidence mapping.

The implementation process of this operation may refer to the operation in 4. However, in this operation, the speed measurement apparatus obtains the second confidence rather than the first confidence according to the object type of the first object and the confidence mapping.

In 10, the first confidence is obtained according to the score and the second confidence.

In the embodiment of the disclosure, the first confidence is correlated with the score. Assume that the first confidence is c₁, the second confidence is c₂, and the score is s. In a possible implementation mode, c₁, c₂, s satisfy formula (16).

c₂=α×s×c₁ (16).

Herein, α is a positive number. In some possible implementation modes, α=1.

In another possible implementation mode, c₁, c₂, s satisfy formula (17).

c₂=α×s×c₁+σ (17).

Herein, α is a positive number, and σ is a real number. In some possible implementation modes, α=1, σ=0.

In another possible implementation mode, c₁, c₂, s satisfy formula (18).

c₂=\sqrt{α×s×c₁σ} (18).

Herein, α is a positive number, and σ is a real number. In some possible implementation modes, α=1, σ=0.

The speed measurement apparatus obtains the first confidence according to the score of the first object and the second confidence, so that the accuracy of the first confidence may be improved.

In some possible implementation modes, the speed measurement apparatus may execute the operation in 9 to obtain a fourth confidence of the fourth transmission parameter. The speed measurement apparatus may obtain the third confidence according to a score of the second object and the fourth confidence.

As an implementation mode in some possible implementation modes, the speed measurement apparatus further executes the following operations before executing the operation in 6.

In 11, a depth image of the first image to be processed is acquired.

In the embodiment of the disclosure, the depth image of the first image to be processed contains depth information of pixels in the first image to be processed. In a possible implementation mode, the speed measurement apparatus receives the depth image input by the user through an input component. The input component includes a keyboard, a mouse, a touch screen, a touch pad, an audio input unit, etc.

In another possible implementation mode, the speed measurement apparatus is configured with a Red Green Blue (RGB) camera and a depth camera. The speed measurement apparatus acquires the depth image of the first image to be processed using the depth camera in a process of acquiring the first image to be processed using the RGB camera. The depth camera may be any one of a structured light camera, a Time Of Flight (TOF) camera, and a binocular stereo vision camera.

In another possible implementation mode, the speed measurement apparatus receives the depth image sent by a fifth terminal. The fifth terminal includes a mobile phone, a computer, a tablet computer, a server, etc. In the embodiment, the fifth terminal may be the same as or different from the first terminal.

In 12, first depth information of the second pixel and second depth information of the third pixel are obtained according to the depth image.

As described above, the depth image contains the depth information of the pixels in the first image to be processed. After acquiring the depth image, the speed measurement apparatus may determine depth information (i.e., the first depth information) of the second pixel and depth information (i.e., the second depth information) of the third pixel according to the depth image.

In 13, a first data point is obtained according to the first depth information and the fifth transmission parameter, and a second data point is obtained according to the second depth information and the fourth transmission parameter.

In a possible implementation mode, an abscissa of the first data point is the first depth information, an abscissa of the second data point is the second depth information, an ordinate of the first data point is the fifth transmission parameter, and an ordinate of the second data point is the fourth transmission parameter. That is, the speed measurement apparatus takes depth information of a pixel as an abscissa and a transmission parameter of the pixel as an ordinate.

In a possible implementation mode, the ordinate of the first data point is the first depth information, the ordinate of the second data point is the second depth information, the abscissa of the first data point is the fifth transmission parameter, and the abscissa of the second data point is the fourth transmission parameter. That is, the speed measurement apparatus takes depth information of a pixel as an ordinate and a transmission parameter of the pixel as an abscissa.

After obtaining the first data point and the second data point, the speed measurement apparatus executes the following operations during execution of the operation in 6.

In 14, curve fitting processing is performed on the first data point and the second data point to obtain the transmission parameter diagram.

Since the first data point and the second data point both contain depth information of a pixel, the transmission parameter diagram obtained by the speed measurement apparatus through the curve fitting processing on the first data point and the second data point also contains the depth information.

Since determination of a scale of a pixel in the first image to be processed according to depth information of the pixel may improve the accuracy of the scale of the pixel in the first image to be processed, the speed measurement apparatus may execute the operation in 14 to obtain the transmission parameter diagram to improve the accuracy of the transmission parameter diagram and further improve the accuracy of the transmission parameter of the pixel in the first image to be processed, thereby improving the accuracy of the speed of the first target.

It is to be understood that, when the third position represents a position in the second image to be processed, the speed measurement apparatus may obtain the transmission parameter diagram of the second image to be processed based on a depth image of the second image to be processed, thereby improving the accuracy of the speed of the first target.

As an implementation mode in some possible implementation modes, the first image to be processed and the second image to be processed are acquired by the same imaging device, and a pose of the imaging device during acquisition of the first image to be processed is the same as that of the imaging device during acquisition of the second image to be processed. As such, scales of pixels at the same position in the first image to be processed and the second image to be processed are the same. For example, pixel a belongs to the first image to be processed, pixel b belongs to the second image to be processed, and a position of pixel a in the first image to be processed is the same as a position of pixel b in the second image to be processed. In such case, a scale of pixel a in the first image to be processed is the same as that of pixel b in the second image to be processed. In some possible implementation modes, the imaging device is a monitoring camera.

Based on the technical solution provided in the embodiments of the disclosure, the embodiments of the disclosure also provide a possible application scene.

As described above, excessive human traffic in a public place usually causes an overcrowding condition and further causes some public accidents. Therefore, how to determine a crowd density of a public place is of great significance.

In the related art, for enhancing the safety in a working, living, or the social environment, monitoring camera devices may be mounted in each public place for safety protection according to video stream information. A video stream acquired by the monitoring camera device may be processed through the technical solution provided in the embodiments of the disclosure to determine a crowd density of the public place and further prevent a public accident effectively.

As an implementation mode in some possible implementation modes, the first target is a person target belonging to a monitored crowd. The monitored crowd refers to a crowd in a monitoring picture captured by the monitoring camera. When the crowd is dense, a distance between persons is relatively short, resulting in a low moving speed of a person. Therefore, it may be determined according to the speed of the first target whether a crowd density of the monitored crowd is excessive.

In a possible implementation mode, the speed measurement apparatus determines that the crowd density of the monitored crowd is excessive when the speed of the first target does not exceed a safety speed threshold. The speed measurement apparatus further acquires a position of the imaging device (the position of the imaging device carries at least one of the number of the imaging device or longitude and latitude information of the imaging device), and sends an alerting instruction including the position to a terminal of a related manager to prompt the manager that the crowd density of the monitored crowd is excessive. Therefore, the probability of occurrence of the public safety accident is reduced.

In some possible implementation modes, the alerting instruction may instruct the terminal to output alerting information that the crowd density of the monitored crowd is excessive in at least one of the following manners: light, voice, text or vibration.

It is to be understood by those skilled in the art that, in the method of the specific implementation modes, the sequence of each operation does not mean a strict execution sequence and is not intended to form any limit to the implementation process, and a specific execution sequence of each operation should be determined by functions and probable internal logic thereof.

The method of the embodiments of the disclosure is described above in detail, and an apparatus of the embodiments of the disclosure will be provided below.

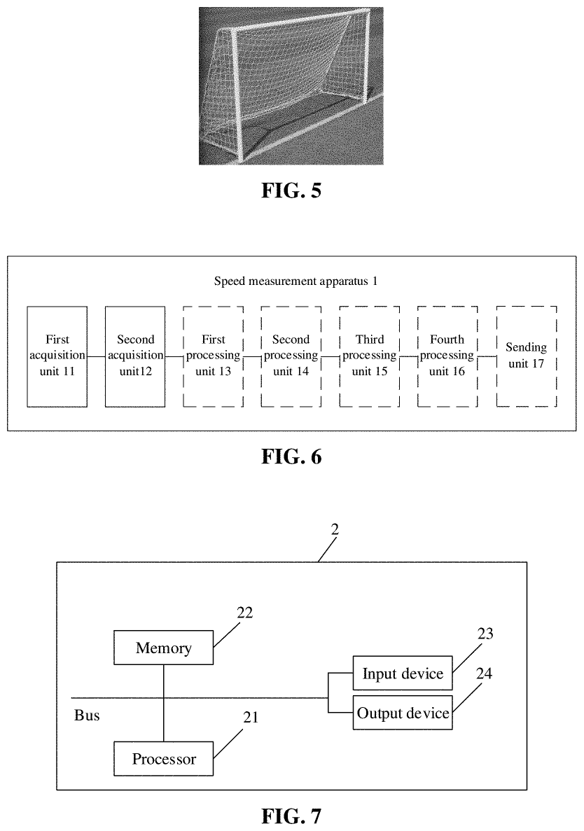

Referring to FIG. 6, FIG. 6 is a structure diagram of a speed measurement apparatus according to an embodiment of the disclosure. The speed measurement apparatus includes a first acquisition unit 11, a second acquisition unit 12, and a first processing unit 13. The first acquisition unit 11 is configured to acquire a first image to be processed and a second image to be processed. The first image to be processed and the second image to be processed both include a first target. The second acquisition unit 12 is configured to acquire a first position of the first target in the first image to be processed, a second position of the first target in the second image to be processed, and a first transmission parameter of a first moving distance. The first moving distance is a distance between the first position and the second position. The first transmission parameter represents a conversion relationship between the first moving distance and a first physical distance. The first physical distance is a physical distance corresponding to the first moving distance. The first physical distance is negatively correlated with a scale of the first position in the first image to be processed, and/or, the first physical distance is negatively correlated with a scale of the second position in the second image to be processed. The first processing unit 13 is configured to obtain a speed of the first target according to the first moving distance, the first transmission parameter, and moving time. The moving time is obtained according to a timestamp of the first image to be processed and a timestamp of the second image to be processed.

In combination with any implementation mode of the disclosure, the first processing unit 13 is configured to obtain a second moving distance according to the first transmission parameter and the first moving distance, and obtain the speed according to the second moving distance and the moving time.

In combination with any implementation mode of the disclosure, the second acquisition unit 12 is configured to acquire a second transmission parameter of a third position, and obtain the first transmission parameter according to the second transmission parameter. The third position is a position on a connecting line between the first position and the second position, the second transmission parameter represents a conversion relationship between a size of a first pixel and a size of a first object point, the first pixel is a pixel determined in the first image to be processed according to the third position, or the first pixel is a pixel determined in the second image to be processed according to the third position, the first object point is an object point corresponding to the first pixel, a first ratio is negatively correlated with a scale of the first pixel in the image, and the first ratio is a ratio of the size of the first pixel to the size of the first object point. The first transmission parameter is positively correlated with the second transmission parameter.

In combination with any implementation mode of the disclosure, the third position is a middle position between the first position and the second position.

In combination with any implementation mode of the disclosure, the second acquisition unit 12 is configured to:

perform object detection processing on the first image to be processed to obtain a position of a first object box and a position of a second object box, the first object box including a first object, and the second object box including a second object;

obtain a first size of the first object according to the position of the first object box, and obtain a second size of the second object according to the position of the second object box;

obtain a third transmission parameter according to the first size and a third size, and obtain a fourth transmission parameter according to the second size and a fourth size, the third size being a physical size of the first object, the third transmission parameter representing a conversion relationship between a fifth size and a sixth size, the fifth size being a size of a second pixel, a position of the second pixel in the first image to be processed being determined according to the position of the first object box, the sixth size being a size of an object point corresponding to the second pixel, the fourth size being a physical size of the second object, the fourth transmission parameter representing a conversion relationship between a seventh size and an eighth size, the seventh size being a size of a third pixel, a position of the third pixel in the second image to be processed being determined according to the position of the second object box, and the eighth size being a size of an object point corresponding to the third pixel;

perform curve fitting processing on the third transmission parameter and the fourth transmission parameter to obtain a transmission parameter diagram of the first image to be processed, a conversion relationship between a ninth size and a tenth size being determined according to a first pixel value in the transmission parameter diagram, the ninth size being a size of a fourth pixel in the first image to be processed, the tenth size being a size of an object point corresponding to the fourth pixel, the first pixel value being a pixel value of a fifth pixel, and a fifth pixel being a pixel corresponding to the fourth pixel in the transmission parameter diagram; and

obtain the second transmission parameter according to a pixel value corresponding to the third position in the transmission parameter diagram.

In combination with any implementation mode of the disclosure, the first acquisition unit 11 is further configured to acquire, before curve fitting processing is performed on the third transmission parameter and the fourth transmission parameter to obtain the transmission parameter diagram of the image to be processed, a confidence mapping. The confidence mapping represents a mapping between an object type and a confidence of a transmission parameter.

The speed measurement apparatus may further include a second processing unit 14. The second processing unit 14 is configured to obtain a first confidence of the third transmission parameter according to an object type of the first object and the confidence mapping. The second acquisition unit 12 is configured to obtain a fifth transmission parameter according to the first confidence and the third transmission parameter, the fifth transmission parameter being positively correlated with the first confidence, and perform curve fitting processing on the fourth transmission parameter and the fifth transmission parameter to obtain the transmission parameter diagram.

In combination with any implementation mode of the disclosure, the speed measurement apparatus 1 may further include a third processing unit 15 and a fourth processing unit 16. The third processing unit 15 is configured to perform, before the first confidence of the third transmission parameter is obtained according to the object type of the first object and the confidence mapping, feature extraction processing on a pixel region in the first object box to obtain feature data. The fourth processing unit 16 is configured to obtain a score of the first object according to the feature data. The score is positively correlated with a confidence of a size of the first object. The second processing unit 14 is configured to obtain a second confidence of the third transmission parameter according to the object type of the first object and the confidence mapping, and obtain the first confidence according to the score and the second confidence. The first confidence is correlated with the score.

In combination with any implementation mode of the disclosure, the second acquisition unit 12 is configured to determine a product of the first confidence and the third transmission parameter to obtain the fifth transmission parameter.

In combination with any implementation mode of the disclosure, the first acquisition unit is further configured to acquire, before curve fitting processing is performed on the fourth transmission parameter and the fifth transmission parameter to obtain the transmission parameter diagram, a depth image of the first image to be processed. The second acquisition unit 12 is further configured to obtain first depth information of the second pixel and second depth information of the third pixel according to the depth image, obtain a first data point according to the first depth information and the fifth transmission parameter, and obtain a second data point according to the second depth information and the fourth transmission parameter. The second acquisition unit 12 is further configured to perform curve fitting processing on the first data point and the second data point to obtain the transmission parameter diagram.

In combination with any implementation mode of the disclosure, the first image to be processed and the second image to be processed are acquired by the same imaging device, and a pose of the imaging device during acquisition of the first image to be processed is the same as that of the imaging device during acquisition of the second image to be processed.

In combination with any implementation mode of the disclosure, the first target is a person target, and the person target belongs to a monitored crowd. The first acquisition unit 11 is further configured to acquire a position of the imaging device when the speed does not exceed a safety speed threshold. The speed measurement apparatus further may include a sending unit 17. The sending unit 17 is configured to send an alerting instruction including the position to a terminal. The alerting instruction is configured to instruct the terminal to output alerting information that a crowd density of the monitored crowd is excessive.

In the embodiment, the first transmission parameter contains scale information of the first position and/or scale information of the second position, and the speed measurement apparatus obtains the speed of the first target according to the first transmission parameter, the first moving distance, and the moving time, so that the accuracy of the speed may be improved.

In some embodiments, functions or modules of the apparatus provided in the embodiments of the disclosure may be configured to execute the method described in the method embodiments and specific implementation thereof may refer to the descriptions about the method embodiments, which will not be elaborated herein for simplicity.

FIG. 7 is a hardware structure diagram of a speed measurement apparatus according to an embodiment of the disclosure. The speed measurement apparatus 2 includes a processor 21, a memory 22, an input device 23, and an output device 24. The processor 21, the memory 22, the input device 23 and the output device 24 are coupled through a connector. The connector includes various interfaces, transmission lines, or buses, etc. No limits are made thereto in the embodiment of the disclosure. It is to be understood that in each embodiment of the disclosure, coupling refers to interconnection implemented in a specific manner, including direct connection or indirect connection through another device, for example, connection through various interfaces, transmission lines and buses.

The processor 21 may be one or more Graphics Processing Units (GPUs). When the processor 21 is one GPU, the GPU may be a single-core GPU, or may be a multi-core GPU. In some possible implementation modes, the processor 21 may be a processor set consisting of multiple GPUs, and multiple processors are coupled with one another through one or more buses. In some possible implementation modes, the processor may also be a processor of another object type, etc. No limits are made in the embodiment of the disclosure.

The memory 22 may be configured to store a computer program instruction and various computer program codes including a program code configured to execute the solutions of the disclosure. Optionally, the memory includes, but not limited to, a Random Access Memory (RAM), a Read-Only Memory (ROM), an Erasable Programmable ROM (EPROM), or a Compact Disc Read-Only Memory (CD-ROM). The memory is configured for related instructions and data.

The input device 23 is configured to input data and/or signals, and the output device 24 is configured to output data and/or signals. The input device 23 and the output device 24 may be independent devices, or may be integrated. It is to be understood that, in the embodiment of the disclosure, the memory 22 may not only be configured to store related instructions but also be configured to store related data. For example, the memory 22 may be configured to store a first image to be processed acquired by the input device 23, or the memory 22 may also be configured to store a speed of a first target obtained by the processor 21, etc. Data specifically stored in the memory is not limited in the embodiment of the disclosure.

It is to be understood that FIG. 7 only illustrates a simplified design of the speed measurement apparatus. In practical applications, the speed measurement apparatus may further include other required components, including, but not limited to, any number of input/output devices, processors, memories, etc. All speed measurement apparatuses capable of implementing the embodiments of the disclosure fall within the scope of protection of the disclosure.

Those of ordinary skill in the art may realize that the units and algorithm steps of each example described in combination with the embodiments disclosed in the disclosure may be implemented by electronic hardware or a combination of computer software and the electronic hardware. Whether these functions are executed by hardware or software depends on specific applications and design constraints of the technical solutions. Professionals may realize the described functions for each specific application by use of different methods, but such realization shall fall within the scope of the disclosure.

Those skilled in the art may clearly learn about that specific working processes of the system, apparatus and unit described above may refer to the corresponding processes in the method embodiments and will not be elaborated herein for convenient and brief description. Those skilled in the art may also clearly know that the embodiments of the disclosure are described with different focuses. For convenient and brief description, the same or similar parts may not be elaborated in different embodiments, and thus parts that are not described or detailed in an embodiment may refer to records in the other embodiments.

In some embodiments provided by the disclosure, it is to be understood that the disclosed system, apparatus, and method may be implemented in another manner For example, the apparatus embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the apparatus or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purposes of the solutions of the embodiments according to a practical requirement. In addition, each functional unit in each embodiment of the disclosure may be integrated into a processing unit, each unit may also physically exist independently, and two or more than two units may also be integrated into a unit.

The embodiments may be implemented completely or partially through software, hardware, firmware or any combination thereof. During implementation with the software, the embodiments may be implemented completely or partially in form of a computer program product. The computer program product includes one or more computer instructions. When the computer program instruction is loaded and executed on a computer, the flows or functions according to the embodiments of the disclosure are completely or partially generated. The computer may be a universal computer, a dedicated computer, a computer network, or another programmable device. The computer instruction may be stored in a computer-readable storage medium or transmitted through the computer-readable storage medium. The computer instruction may be transmitted from one website, computer, server or data center to another website, computer, server or data center in a wired (for example, a coaxial cable, an optical fiber and a Digital Subscriber Line (DSL)) or wireless (for example, infrared, radio and microwave) manner The computer-readable storage medium may be any available medium accessible for the computer or a data storage device, such as a server and a data center, including one or more integrated available media. The available medium may be a magnetic medium (for example, a floppy disk, a hard disk and a magnetic tape), an optical medium (for example, a Digital Versatile Disc (DVD)), a semiconductor medium (for example, a Solid State Disk (SSD)) or the like.

It can be understood by those of ordinary skill in the art that all or part of the flows in the method of the abovementioned embodiments may be completed by instructing related hardware through a computer program, the program may be stored in a computer-readable storage medium, and when the program is executed, the flows of each method embodiment may be included. The storage medium includes various media capable of storing program codes, such as a ROM, a RAM, a magnetic disk, or an optical disk.

### INDUSTRIAL APPLICABILITY

The disclosure discloses a speed measurement method and apparatus, an electronic device, and a storage medium. The method includes the following operations. A first image to be processed and a second image to be processed are acquired, and each of the first image to be processed and the second image to be processed includes a first target. A first position of the first target in the first image to be processed, a second position of the first target in the second image to be processed, and a first transmission parameter of a first moving distance are acquired. A speed of the first target is obtained according to the first moving distance, the first transmission parameter, and moving time. The moving time is obtained according to a timestamp of the first image to be processed and a timestamp of the second image to be processed.

1. A speed measurement method, comprising:
acquiring a first image to be processed and a second image to be processed, each of the first image to be processed and the second image to be processed comprising a first target;
acquiring a first position of the first target in the first image to be processed, a second position of the first target in the second image to be processed, and a first transmission parameter of a first moving distance, wherein the first moving distance is a distance between the first position and the second position, the first transmission parameter represents a conversion relationship between the first moving distance and a first physical distance, the first physical distance is a physical distance corresponding to the first moving distance, the first physical distance is negatively correlated with a scale of the first position in the first image to be processed, and/or, the first physical distance is negatively correlated with a scale of the second position in the second image to be processed; and
obtaining a speed of the first target according to the first moving distance, the first transmission parameter and moving time, the moving time being obtained according to a timestamp of the first image to be processed and a timestamp of the second image to be processed.

2. The method of claim 1, wherein obtaining the speed of the first target according to the first moving distance, the first transmission parameter and the moving time comprises:
obtaining a second moving distance according to the first transmission parameter and the first moving distance; and
obtaining the speed according to the second moving distance and the moving time.

3. The method of claim 1, wherein acquiring the first transmission parameter of the first moving distance comprises:
acquiring a second transmission parameter of a third position, wherein the third position is a position on a connecting line between the first position and the second position, the second transmission parameter represents a conversion relationship between a size of a first pixel and a size of a first object point, the first pixel is a pixel determined in the first image to be processed according to the third position, or the first pixel is a pixel determined in the second image to be processed according to the third position, the first object point is an object point corresponding to the first pixel, a first ratio is a ratio of the size of the first pixel to the size of the first object point and negatively correlated with a scale of the first pixel in the first image or the second image; and
obtaining the first transmission parameter according to the second transmission parameter, the first transmission parameter being positively correlated with the second transmission parameter.

4. The method of claim 3, wherein the third position is a middle position between the first position and the second position.

5. The method of claim 3, wherein acquiring the second transmission parameter of the third position comprises:
performing object detection processing on the first image to be processed to obtain a position of a first object box and a position of a second object box, the first object box comprising a first object, and the second object box comprising a second object;
obtaining a first size of the first object according to the position of the first object box, and obtaining a second size of the second object according to the position of the second object box;
obtaining a third transmission parameter according to the first size and a third size, and obtaining a fourth transmission parameter according to the second size and a fourth size, wherein the third size is a physical size of the first object, the third transmission parameter represents a conversion relationship between a fifth size and a sixth size, the fifth size is a size of a second pixel, a position of the second pixel in the first image to be processed is determined according to the position of the first object box, the sixth size is a size of an object point corresponding to the second pixel, the fourth size is a physical size of the second object, the fourth transmission parameter represents a conversion relationship between a seventh size and an eighth size, the seventh size is a size of a third pixel, a position of the third pixel in the second image to be processed is determined according to the position of the second object box, and the eighth size is a size of an object point corresponding to the third pixel;
performing curve fitting processing on the third transmission parameter and the fourth transmission parameter to obtain a transmission parameter diagram of the first image to be processed, wherein a conversion relationship between a ninth size and a tenth size is determined according to a first pixel value in the transmission parameter diagram, the ninth size is a size of a fourth pixel in the first image to be processed, the tenth size is a size of an object point corresponding to the fourth pixel, the first pixel value is a pixel value of a fifth pixel, and a fifth pixel is a pixel corresponding to the fourth pixel in the transmission parameter diagram; and
obtaining the second transmission parameter according to a pixel value corresponding to the third position in the transmission parameter diagram.

6. The method of claim 5, before performing curve fitting processing on the third transmission parameter and the fourth transmission parameter to obtain the transmission parameter diagram of the first image to be processed, further comprising:
acquiring a confidence mapping, the confidence mapping representing a mapping between an object type and a confidence of a transmission parameter; and
obtaining a first confidence of the third transmission parameter according to an object type of the first object and the confidence mapping, wherein
performing curve fitting processing on the third transmission parameter and the fourth transmission parameter to obtain the transmission parameter diagram of the first image to be processed comprises:
obtaining a fifth transmission parameter according to the first confidence and the third transmission parameter, the fifth transmission parameter being positively correlated with the first confidence; and
performing curve fitting processing on the fourth transmission parameter and the fifth transmission parameter to obtain the transmission parameter diagram.

7. The method of claim 6, before obtaining the first confidence of the third transmission parameter according to the object type of the first object and the confidence mapping, further comprising:
performing feature extraction processing on a pixel region in the first object box to obtain feature data; and
obtaining a score of the first object according to the feature data, the score being positively correlated with a confidence of a size of the first object, wherein obtaining the first confidence of the third transmission parameter according to the object type of the first object and the confidence mapping comprises:
obtaining a second confidence of the third transmission parameter according to the object type of the first object and the confidence mapping; and
obtaining the first confidence according to the score and the second confidence, the first confidence being correlated with the score.

8. The method of claim 6, wherein obtaining the fifth transmission parameter according to the first confidence and the third transmission parameter comprises:
determining a product of the first confidence and the third transmission parameter to obtain the fifth transmission parameter.

9. The method of claim 6, before performing curve fitting processing on the fourth transmission parameter and the fifth transmission parameter to obtain the transmission parameter diagram, further comprising:
acquiring a depth image of the first image to be processed;
obtaining first depth information of the second pixel and second depth information of the third pixel according to the depth image; and
obtaining a first data point according to the first depth information and the fifth transmission parameter, and obtaining a second data point according to the second depth information and the fourth transmission parameter, wherein
performing curve fitting processing on the fourth transmission parameter and the fifth transmission parameter to obtain the transmission parameter diagram comprises:
performing curve fitting processing on the first data point and the second data point to obtain the transmission parameter diagram.

10. The method of claim 1, wherein the first image to be processed and the second image to be processed are acquired by a same imaging device, and a pose of the imaging device during acquisition of the first image to be processed is the same as that of the imaging device during acquisition of the second image to be processed.

11. The method of claim 10, wherein the first target is a person target, the person target belonging to a monitored crowd; and the method further comprises:
acquiring a position of the imaging device when the speed does not exceed a safety speed threshold; and
sending an alerting instruction comprising the position to a terminal, the alerting instruction being configured to instruct the terminal to output alerting information that a crowd density of the monitored crowd is excessive.

12. A speed measurement apparatus, comprising:
a processor; and
a non-transitory computer-readable storage medium for storing instructions executable by the processor;
wherein the processor is configured to:
acquire a first image to be processed and a second image to be processed, each of the first image to be processed and the second image to be processed comprising a first target;
acquire a first position of the first target in the first image to be processed, a second position of the first target in the second image to be processed, and a first transmission parameter of a first moving distance, wherein the first moving distance is a distance between the first position and the second position, the first transmission parameter represents a conversion relationship between the first moving distance and a first physical distance, the first physical distance is a physical distance corresponding to the first moving distance, the first physical distance is negatively correlated with a scale of the first position in the first image to be processed, and/or, the first physical distance is negatively correlated with a scale of the second position in the second image to be processed; and
obtain a speed of the first target according to the first moving distance, the first transmission parameter and moving time, the moving time being obtained according to a timestamp of the first image to be processed and a timestamp of the second image to be processed.

13. The apparatus of claim 12, wherein the processor is configured to:
obtain a second moving distance according to the first transmission parameter and the first moving distance; and
obtain the speed according to the second moving distance and the moving time.

14. The apparatus of claim 12, wherein the processor is configured to:
acquire a second transmission parameter of a third position, wherein the third position is a position on a connecting line between the first position and the second position, the second transmission parameter represents a conversion relationship between a size of a first pixel and a size of a first object point, the first pixel is a pixel determined in the first image to be processed according to the third position, or the first pixel is a pixel determined in the second image to be processed according to the third position, the first object point is an object point corresponding to the first pixel, a first ratio is a ratio of the size of the first pixel to the size of the first object point and negatively correlated with a scale of the first pixel in the first image or the second image; and
obtain the first transmission parameter according to the second transmission parameter, the first transmission parameter being positively correlated with the second transmission parameter.

15. The apparatus of claim 14, wherein the processor is configured to:
perform object detection processing on the first image to be processed to obtain a position of a first object box and a position of a second object box, the first object box comprising a first object, and the second object box comprising a second object;
obtain a first size of the first object according to the position of the first object box, and obtain a second size of the second object according to the position of the second object box;
obtain a third transmission parameter according to the first size and a third size, and obtain a fourth transmission parameter according to the second size and a fourth size, wherein the third size is a physical size of the first object, the third transmission parameter represents a conversion relationship between a fifth size and a sixth size, the fifth size is a size of a second pixel, a position of the second pixel in the first image to be processed is determined according to the position of the first object box, the sixth size is a size of an object point corresponding to the second pixel, the fourth size is a physical size of the second object, the fourth transmission parameter represents a conversion relationship between a seventh size and an eighth size, the seventh size is a size of a third pixel, a position of the third pixel in the second image to be processed is determined according to the position of the second object box, and the eighth size is a size of an object point corresponding to the third pixel;
perform curve fitting processing on the third transmission parameter and the fourth transmission parameter to obtain a transmission parameter diagram of the first image to be processed, wherein a conversion relationship between a ninth size and a tenth size is determined according to a first pixel value in the transmission parameter diagram, the ninth size is a size of a fourth pixel in the first image to be processed, the tenth size is a size of an object point corresponding to the fourth pixel, the first pixel value is a pixel value of a fifth pixel, and a fifth pixel is a pixel corresponding to the fourth pixel in the transmission parameter diagram; and
obtain the second transmission parameter according to a pixel value corresponding to the third position in the transmission parameter diagram.

16. The apparatus of claim 15, wherein the processor is configured to, before curve fitting processing is performed on the third transmission parameter and the fourth transmission parameter to obtain the transmission parameter diagram of the first image to be processed,
acquire a confidence mapping, the confidence mapping representing a mapping between an object type and a confidence of a transmission parameter; and
obtain a first confidence of the third transmission parameter according to an object type of the first object and the confidence mapping; and
wherein the processor is further configured to:
obtain a fifth transmission parameter according to the first confidence and the third transmission parameter, the fifth transmission parameter being positively correlated with the first confidence; and
perform curve fitting processing on the fourth transmission parameter and the fifth transmission parameter to obtain the transmission parameter diagram.

17. The apparatus of claim 16, wherein the processor is configured to, before the first confidence of the third transmission parameter is obtained according to the object type of the first object and the confidence mapping,
perform feature extraction processing on a pixel region in the first object box to obtain feature data; and
obtain a score of the first object according to the feature data, the score being positively correlated with a confidence of a size of the first object;
wherein the processor is further configured to:
obtain a second confidence of the third transmission parameter according to the object type of the first object and the confidence mapping; and
obtain the first confidence according to the score and the second confidence, the first confidence being correlated with the score.

18. The apparatus of claim 16, wherein the processor is configured to, before curve fitting processing is performed on the fourth transmission parameter and the fifth transmission parameter to obtain the transmission parameter diagram,
acquire a depth image of the first image to be processed;
obtain first depth information of the second pixel and second depth information of the third pixel according to the depth image; and
obtain a first data point according to the first depth information and the fifth transmission parameter, and obtain a second data point according to the second depth information and the fourth transmission parameter,
wherein the processor is further configured to perform curve fitting processing on the first data point and the second data point to obtain the transmission parameter diagram.

19. The apparatus of claim 12, wherein the first target is a person target, the person target belonging to a monitored crowd, and the processor is configured to:
acquire a position of an imaging device when the speed does not exceed a safety speed threshold; and
send an alerting instruction comprising the position to a terminal, the alerting instruction being configured to instruct the terminal to output alerting information that a crowd density of the monitored crowd is excessive.

20. A non-transitory computer-readable storage medium, having a computer program stored thereon, wherein the computer program comprises a program instruction, and the program instruction is executed by a processor to enable the processor to execute a speed measurement method, the method comprising:
acquiring a first image to be processed and a second image to be processed, each of the first image to be processed and the second image to be processed comprising a first target;
acquiring a first position of the first target in the first image to be processed, a second position of the first target in the second image to be processed, and a first transmission parameter of a first moving distance, wherein the first moving distance is a distance between the first position and the second position, the first transmission parameter represents a conversion relationship between the first moving distance and a first physical distance, the first physical distance is a physical distance corresponding to the first moving distance, the first physical distance is negatively correlated with a scale of the first position in the first image to be processed, and/or, the first physical distance is negatively correlated with a scale of the second position in the second image to be processed; and
obtaining a speed of the first target according to the first moving distance, the first transmission parameter and moving time, the moving time being obtained according to a timestamp of the first image to be processed and a timestamp of the second image to be processed.
